(19) United States
(12) Patent Application Publication
(10) Pub. No.: US 2005/0278934 A1
(43) Pub. Date: Dec. 22, 2005

(54) Device and method for fastening structural members

(76) Inventor: Brian Orchard, London (CA)

Correspondence Address: ANISSIMOFF & ASSOCIATES;RICHMOND NORTH OFFICE CENTRE, SUITE 201, 235 NORTH CENTRE RD., LONDON, ON, N5X 4E7, CA

(21) Appl. No.: 10/498,379

(22) PCT Filed: Mar. 19, 2004
(86) PCT No.: PCT/CA04/00410

§ 371 Date: Oct. 19, 2004

(51) Int. Cl. B23P 11/00; B23P 17/00

(52) U.S. Cl. 29/525.11; 29/799

(57) ABSTRACT

The present invention provides a device and method for fastening structural members, particularly for fastening a deck member to a deck joist. The device and method provide the ability to affix fasteners in a manner which reduces their visibility on the deck and which reduces the occurrence of moisture infiltration around the fastener. The device has a base plate having at least two bores therethrough and at least two jig bodies affixed in different orientations atop the base plate, each of the jig bodies having an angled bore, the angled bores in communication with a respective one of the base plate bores, at least one of the bottom ends of the angled bores in communication with a space between a pair of deck members, the angled bore in communication with the space for receiving a fastener drivable therethrough into a side face of one the deck members and into a joist below.

### FIELD OF THE INVENTION

The present invention relates to a device and method for fastening structural members, particularly for fastening a deck member to a deck joist.

### BACKGROUND OF THE INVENTION

In the construction of decks, deck members are typically fastened to underlying joists by means of fasteners, such as screws, nails, etc., driven through the top surface of the deck member into the joist below. This method results in fasteners which are visible and exposed to the weather. Visible fasteners are unsightly and exposure to weather, particularly moisture, can lead to infiltration of moisture. Infiltration of moisture can lead to premature cracking and rotting of the deck.

Thus, there is a need in the art for a method of fastening a deck member to a deck joist whereby the fastener is less visible and less exposed to the weather.

### SUMMARY OF THE INVENTION

According to an aspect of the present invention, there is provided a device for affixing a first structural member to a second structural member, the first structural member positioned atop the second structural member, the device comprising: a base plate positionable atop a pair of first structural members positioned in spaced-apart relation form each other, the base plate having at least two bores therethrough from a top surface to a bottom surface; means for retaining the base plate in a desired position relative to the first structural members; and at least two jig bodies affixed in different orientations atop and relative to the base plate, each of the jig bodies each having an angled bore having a bottom end extending through bottom faces of the jig bodies, the angled bores in communication with a respective one of the base plate bores, at least one of the bottom ends of the angled bores in communication with a space between the pair of first structural members, the angled bore in communication with the space defining a centerline extending to a position on one of the first structural members in spaced relation from a top surface thereof, the angled bore in communication with the space for receiving a fastener drivable therethrough into a side face of the one first structural member, through the one first structural member, and into the second structural member therebeneath.

According to another aspect of the present invention, there is provided a method of affixing a first structural member to a second structural member, the first structural member positioned atop the second structural member, the method comprising the steps of: positioning a base plate atop a pair of the first structural members positioned in spaced-apart relation from each other atop the second structural member, the base plate having at least two bores therethrough from a top surface to a bottom surface; retaining the base plate in a desired position relative to the first structural members; affixing at least two jig bodies atop the base plate in different orientations, the jig bodies each having an angled bore having a bottom end extending through a bottom face of the jig body, the angled bores in communication with a respective base plate bore, at least a one of the bottom ends of the angled bores in communication with a space between the pair of first structural members, the angled bore in communication with the space defining a centerline extending to a position on one of the first structural members in spaced relation from a top surface thereof; and driving a fastener through the angled bore in communication with the space into a side face of the one first structural member, through the one first structural member, and into the second structural member therebeneath.

According to yet another aspect of the present invention, there is provided a device for fastening a first structural member to a second structural member, the first structural member positioned atop the second structural member, the device comprising: a base plate positionable atop a pair of first structural members positioned in spaced-apart relation from each other; three jig bodies immovably affixed in different orientations atop the base plate, each jig body having an angled bore therethrough; each angled bore having a top and a bottom, the bottom of each angled bore in communication with an aperture through the base plate; one or more of the angled bores in communication with a space between the pair of first structural members, the one or more angled bores for receiving a fastener drivable therethrough into a side face of one of the first structural members and into the second structural member.

The present invention advantageously provides a simple, efficient, flexible and easy way of fastening structural members together. The present device permits driving fasteners in a consistent manner resulting in a join between structural members in which the fastener is less visible and the join less susceptible to infiltration by water. Since the jig bodies of the device are affixed to a base plate, there are no moving parts to wear out or to cause difficulties in operation in use.

In a preferred embodiment, the first structural members are elongated deck members and the second structural member is a joist. In the construction of a deck, the deck members are positioned generally parallel to each other and generally perpendicular to the joist. The deck members having generally coplanar top surfaces and are spaced apart by a predetermined spacing. Although the device of the present invention is particularly useful in the construction of decks, one skilled in the art understands that it may also be used in the construction of other structures.

The device comprises at least two jig bodies affixed to a base plate in different orientations. Such an arrangement permits driving of fasteners into deck member at different angles without having to move a jig body. Thus, the device is both versatile, having more than one orientation for driving screws, and robust, having no moving parts. Preferably, the device has three jig bodies, preferably each jig body has an orientation matching a standard angle at which one skilled in the art typically drives fasteners. In a preferred embodiment of the device, the bottoms of each angled bore are positioned to substantially form a line. One of the jig bodies is oriented to permit driving the fastener at an angle of about 45 degrees in respect of the line, another of the jig bodies is oriented to permit driving the fastener at an angle of about 90 degrees in respect of the line, and another of the jig bodies is oriented to permit driving the fastener at an angle of about 135 degrees in respect of the line.

The device may further comprise guide sleeves extending through the angled bores of the jig bodies and protruding from the bottom of the angles bores. Guide sleeves help guide fastening means along the correct angle. Preferably, guide sleeves are generally cylindrical to accommodate a generally cylindrical fastener.

The angled bores form an angle with a bottom surface of each of their respective jig bodies which is appropriate for the type of construction and structural elements. For decks utilizing elongated deck members and joists, the angle is preferably in a range of about 45 to 60 degrees, more preferably about 50 degrees.

To facilitate proper placement of the device on the first structural members, the base plate further may have a viewing window therethrough. The viewing window is positioned forward of the bottoms of the angled bores to permit visualization of the side face of the structural member through which the fastener is to be driven. As indicated above, the bottom of each angled bore is in communication with an aperture in the base plate. Each angled bore may be associated with its own separate aperture. Alternatively, two or more of the apertures may form a single larger opening in the base plate. In one embodiment, the viewing window and the apertures together form one continuous opening in the base plate.

The device may further comprise means for retaining the base plate in a desired position relative to the structural members. Any suitable means known in the art may be used. In a preferred embodiment, the means for retaining the base plate in a desired position relative to the deck members may be index pins.

The device may further comprise a handle affixed atop the base plate. A handle is advantageous for carrying the device and setting it in the proper location on the structural members. In a preferred embodiment, the handle is T-shaped having a single post perpendicular to the base plate and topped by a horizontal gripping member. In another preferred embodiment, the handle has an inverted U-shape having two spaced apart posts each perpendicular to the base plate and connected by a horizontal gripping member.

Fasteners useful in the present invention may be screws, nails or any elongated fastening means that can be driven through the angled bore. Fasteners are preferably generally cylindrical. A particularly useful fastener is a screw having a head and a body, the head having a diameter only slightly larger than the diameter of the body. The head may be sized to just fit into the angled bore, or guide sleeve if a guide sleeve is used, so that shifting of the screw in the angled bore is reduced and the proper driving angle is maintained. An elongated drill chuck may be used to accommodate the length of the angled bore to enable the screw to be driven all the way into the deck member. The drill chuck may be equipped with a stop which prevents the screw from being driven too far into the deck member. Guide holes may be pre-drilled into the deck member at the correct angle by using the device of the present invention and drill bits designed to fit in and through the angled bore of the device.

U.S. patent application Ser. No. 10/414,057 filed Apr. 15, 2003 and published on Dec. 4, 2003 under number 2003/0221391 is herein incorporated by reference in its entirety.

### BRIEF DESCRIPTION OF THE DRAWINGS

In order that the invention may be more clearly understood, embodiments thereof will now be described in detail by way of example, with reference to the accompanying drawings, in which:

FIG. 1 is a perspective view of an embodiment of a device of the present invention;

FIG. 2 is a front view of the device of FIG. 1;

FIG. 3 is a bottom view of the device of FIG. 1;

FIG. 4 is a top view of the device of FIG. 1;

FIG. 5 is a side view of one jig body of the device of FIG. 1;

FIG. 6 is a perspective view of an alternate embodiment of a device of the present invention;

FIG. 7 depicts a screw suitable for use with a device of the present invention; and,

FIG. 8 is a side cross-sectional view of the device of FIGS. 1-5 in use for fastening a deck member to a deck joist.

### DETAILED DESCRIPTION

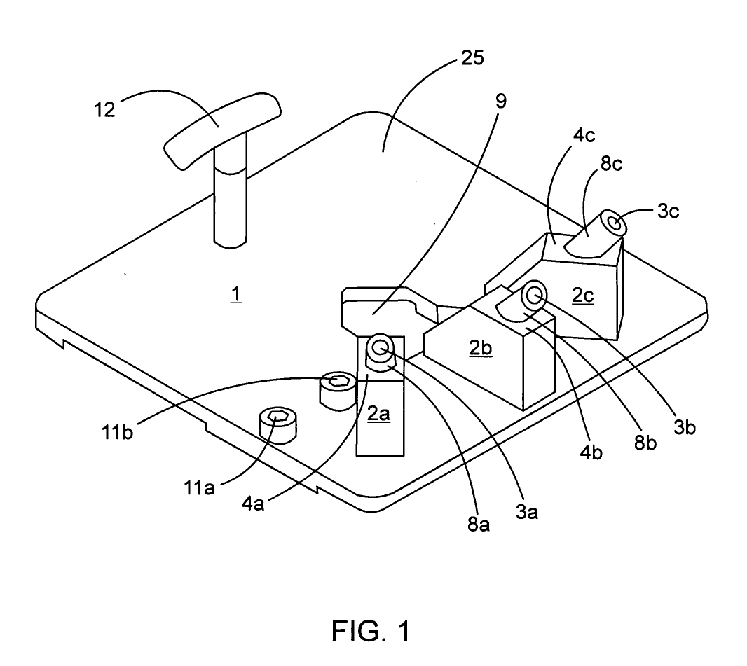

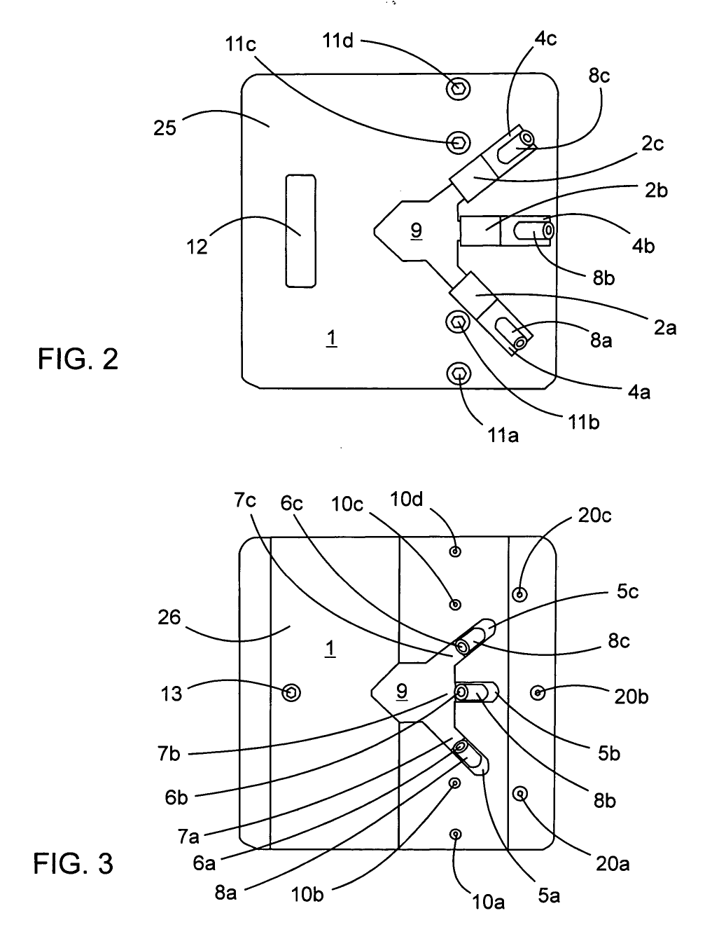

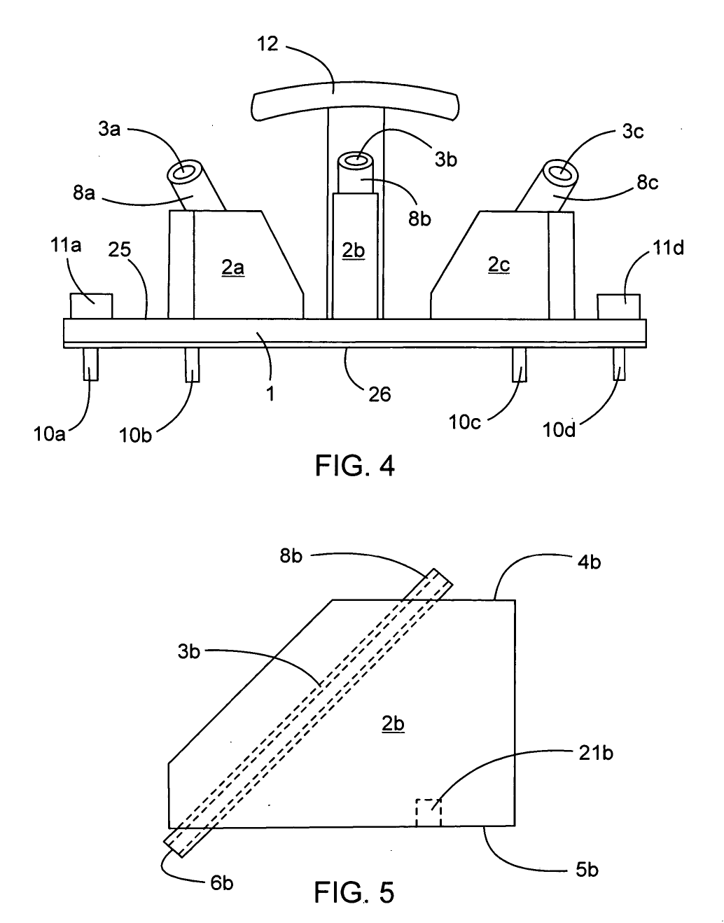

Referring to FIGS. 1-5, a device of one embodiment of the present invention is depicted. A base plate I having a top surface 25 and a bottom surface 26 is provided having three jig bodies 2a, 2b, 2c affixed on the top surface 25 by bolts 20a,20b,20c from underneath the base plate 1. The bolts 20a,20b,20c may be countersunk into the bottom surface 26 of the base plate 1 and are threaded into mating connectors (one shown at 21b in FIG. 5) which are countersunk into the underside of the jig bodies. The jig bodies have angled bores 3a,3b,3c passing therethrough from top faces 4a,4b,4c to bottom faces 5a,5b,5c of the jig bodies at an angle of 50 degrees with respect to the bottom surface 26 of the base plate 1. The angled bores have bottoms 6a,6b,6c in communication with respective apertures 7a,7b,7c in the base plate 1. The bottoms 6a,6b,6c of the angled bores 3a,3b,3c are positioned to substantially form a line. One of the jig bodies 2a is oriented to permit driving a fastener at an angle of about 45 degrees in respect of the line, another of the jig bodies 2b is oriented to permit driving a fastener at an angle of about 90 degrees in respect of the line, and another of the jig bodies 2c is oriented to permit driving a fastener at an angle of about 135 degrees in respect of the line. The angled bores 3a,3b,3c have cylindrical guide sleeves 8a,8b,8c therein for receiving and guiding the fastener.

Still referring to FIGS. 1-5, the base plate 1 further comprises a viewing window 9. The viewing window 9 and the apertures 7a,7b,7c together form a single continuous opening in the base plate 1. A row of four index pins 10a,10b,10c,10d, parallel to the line formed by the bottoms 6a,6b,6c of the angled bores, are used to aid in positioning the device in relation to an elongated deck member (not shown). The index pins 10a,10b,10c,10d are contiguous with bolts 11a,11b,11c,11d which attach the pins 10a,10b,10c,10d to the base plate 1. A T-shaped handle 12 is attached to the base plate 1 by a bolt 13 countersunk into the bottom surface 26 of the base plate 1.

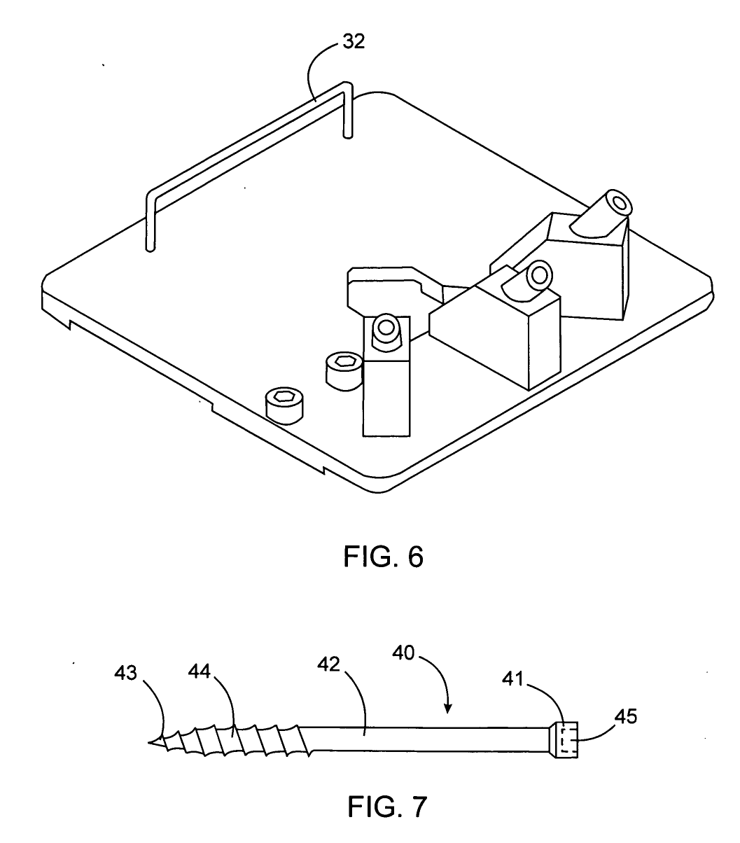

An alternate embodiment of a device of the present invention having an inverted U-shaped handle 32 is depicted in FIG. 6. In other respects, the embodiment of FIG. 6 is similar to the one described in relation to FIGS. 1-5.

FIG. 7 depicts a screw 40 suitable for use as a deck fastener with a device of the present invention. The screw 40 comprises a substantially cylindrical head 41 at a top end of a substantially cylindrical body 42. The body 42 has a narrowed tip 43 and a set of screw flights 44 extending from the tip 43 part way up the body 42 towards the head 41. The head 41 has a square driver notch 45 therein for receiving a screw driver or drill bit. The screw is long enough to pass through a deck member into a joist so that the deck member is firmly attached to the joist. The head 41 has a diameter just small enough to fit within the cylindrical sleeves of the device and the body 42 has a diameter that is only slightly smaller than the head 41. The inner diameter of the cylindrical sleeves and the diameters of the screw's body and head depend on the particular application and may be easily determined by one skilled in the art. The inner diameter of the cylindrical sleeves may be about 0.5 inches for a decking application.

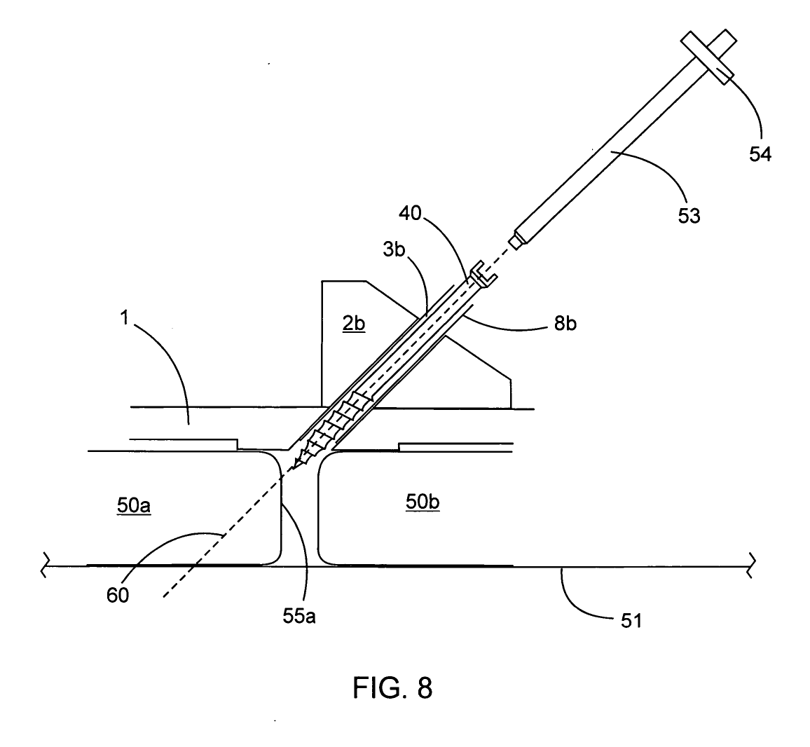

FIG. 8 is a side cross-sectional view of the device of FIGS. 1-5 in use for fastening a deck member to a deck joist. A pair of elongated deck members 50a,50b in spaced-apart relation shown end-on are positioned parallel to each other on a joist 51. The pair of elongated deck members 50a,50b are perpendicular to the joist 51. The device having base plate 1, jig body 2b, angled bore 3b through the jig body 2b and cylindrical guide sleeve 8b in the angles bore 3b is positioned atop the pair of deck members 50a,50b in proper position by index pins (not shown). A screw 40 is set into the guide sleeve 8b where it is held at a proper angle (50 degrees). A drill bit 53 together with a drill (not shown) is used to drive the screw 40 along a path described by the dashed line 60 into a side face 55a of the deck member 50a and then into the joist 51. The drill bit 53 is equipped with a stop 54 to prevent the screw 40 from being driven too far into the deck member 50a.

Other advantages which are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A device for affixing a first structural member to a second structural member, the first structural member positioned atop the second structural member, the device comprising: a base plate positionable atop a pair of first structural members positioned in spaced-apart relation form each other, the base plate having at least two bores therethrough from a top surface to a bottom surface; means for retaining the base plate in a desired position relative to the first structural members; and at least two jig bodies affixed in different orientations atop and relative to the base plate, each of the jig bodies each having an angled bore having a bottom end extending through bottom faces of the jig bodies, the angled bores in communication with a respective one of the base plate bores, at least one of the bottom ends of the angled bores in communication with a space between the pair of first structural members, the angled bore in communication with the space defining a centerline extending to a position on one of the first structural members in spaced relation from a top surface thereof, the angled bore in communication with the space for receiving a fastener drivable therethrough into a side face of the one first structural member, through the one first structural member, and into the second structural member therebeneath.

2. The device according to claim 1, wherein the first structural members comprise elongated deck members and the second structural member comprises a joist, the deck members positioned generally parallel to each other and generally perpendicular to the joist, the deck members having generally coplanar top surfaces and being spaced apart by a predetermined spacing.

3. A method of affixing a first structural member to a second structural member, the first structural member positioned atop the second structural member, the method comprising the steps of: positioning a base plate atop a pair of the first structural members positioned in spaced-apart relation from each other atop the second structural member, the base plate having at least two bores therethrough from a top surface to a bottom surface; retaining the base plate in a desired position relative to the first structural members; affixing at least two jig bodies atop the base plate in different orientations, the jig bodies each having an angled bore having a bottom end extending through a bottom face of the jig body, the angled bores in communication with a respective base plate bore, at least a one of the bottom ends of the angled bores in communication with a space between the pair of first structural members, the angled bore in communication with the space defining a centerline extending to a position on one of the first structural members in spaced relation from a top surface thereof; and driving a fastener through the angled bore in communication with the space into a side face of the one first structural member, through the one first structural member, and into the second structural member therebeneath.

4. The method according to claim 3, wherein the first structural members comprise elongated deck members and the second structural member comprises a joist, the deck members positioned generally parallel to each other and generally perpendicular to the joist, the deck members having generally coplanar top surfaces and being spaced apart by a predetermined spacing.

5. A device for fastening a first structural member to a second structural member, the first structural member positioned atop the second structural member, the device comprising:
(a) a base plate positionable atop a pair of first structural members positioned in spaced-apart relation from each other;
(b) three jig bodies immovably affixed in different orientations atop the base plate, each jig body having an angled bore therethrough; each angled bore having a top and a bottom, the bottom of each angled bore in communication with an aperture through the base plate;
(c) one or more of the angled bores in communication with a space between the pair of first structural members, the one or more angled bores for receiving a fastener drivable therethrough into a side face of one of the first structural members and into the second structural member.

6. The device according to claim 5, wherein the first structural members comprise elongated deck members and the second structural member comprises a joist, the deck members positioned generally parallel to each other and generally perpendicular to the joist, the deck members having generally coplanar top surfaces and being spaced apart by a predetermined spacing.

7. The device according to claim 6, further comprising guide sleeves extending through the angled bores and protruding from the bottom of the angles bores.

8. The device according to claim 7, wherein each of the angled bores forms an angle with a bottom surface of each of their respective jig bodies, the angle in a range of 45 to 60 degrees.

9. The device according to claim 8, wherein the angle is about 50 degrees.

10. The device according to claim 6, wherein the base plate further has a viewing window therethrough, the viewing window positioned forward of the bottoms of the angled bores to permit visualization of the side face.

11. The device according to claim 10, wherein the aperture through the base plate in communication with each angled bore, and the viewing window form one continuous opening in the base plate.

12. The device according to claim 6, further comprising means for retaining the base plate in a desired position relative to the deck members.

13. The device according to claim 12, wherein the means for retaining the base plate in a desired position relative to the deck members are index pins.

14. The device according to claim 6, further comprising a handle affixed atop the base plate.

15. The device according to claim 14, wherein the handle is T-shaped.

16. The device according to claim 14, wherein the handle has an inverted U-shape

17. The device according to claim 6, wherein the bottoms of each angled bore are positioned to substantially form a line, one jig body is oriented to permit driving the fastener at an angle of about 45 degrees in respect of the line, another of the jig bodies is oriented to permit driving the fastener at an angle of about 90 degrees in respect of the line, and another of the jig bodies is oriented to permit driving the fastener at an angle of about 135 degrees in respect of the line.
